(19) United States
(12) Patent Application Publication
(10) Pub. No.: US 2022/0291090 A1
(43) Pub. Date: Sep. 15, 2022

(54) CHIP FOR SAMPLE SEPARATION, SAMPLE DETECTION DEVICE AND SAMPLE DETECTION METHOD

(71) Applicant: National Tsing Hua University, Hsinchu City (TW)

(72) Inventors: Kuan-Hung Chen, Hsinchu City (TW); Fan-Gang Tseng, Hsinchu City (TW)

(73) Assignee: National Tsing Hua University, Hsinchu City (TW)

(21) Appl. No.: 17/369,866

(22) Filed: Jul. 7, 2021

(30) Foreign Application Priority Data
Mar. 11, 2021 (TW) 110108703

(51) Int. Cl. G01N 1/22; G01N 21/65

(52) U.S. Cl. CPC G01N 1/2202; G01N 21/658

(57) ABSTRACT

A chip for sample separation including a first substrate, a first electrode, a first dielectric layer, a second substrate, a second electrode, a second dielectric layer, and a flow channel layer is provided. The first electrode is disposed on the first substrate. The first dielectric layer is disposed on the first electrode and includes a first opening. The second electrode is disposed on the second substrate. The second dielectric layer is disposed on the second electrode and includes a second opening. An area of the first electrode exposed by the first opening is smaller than an area of the second electrode exposed by the second opening. The flow channel layer is sandwiched between the first dielectric layer and the second dielectric layer and includes a through hole. The through hole communicates between the first opening and the second opening.

### CROSS-REFERENCE TO RELATED APPLICATION

This application claims the priority benefit of Taiwan application serial no. 110108703, filed on Mar. 11, 2021. The entirety of the above-mentioned patent application is hereby incorporated by reference herein and made a part of this specification.

### BACKGROUND

### Technical Field

The disclosure relates to a chip, a detection device and a detection method, and particularly to a chip for sample separation, a sample detection device, and a sample detection method using surface-enhanced Raman spectrum.

### Description of Related Art

At present, when analyzing the pathogen of a disease, the detection process is complicated and the detection time is too long, thus often delaying the optimal treatment time. For example, bacterial isolation is traditionally done by centrifugation, immune antibody targeting, and dialysis, but these methods require long waiting times and complicated techniques to achieve isolation.

### SUMMARY

The disclosure provides a chip for sample separation, a sample detection device, and a sample detection method using surface-enhanced Raman spectrum, which can shorten the sample detection process and detection time.

The disclosure provides a chip for sample separation including a first substrate, a first electrode, a first dielectric layer, a second substrate, a second electrode, a second dielectric layer, and a flow channel layer is provided. The first electrode is disposed on the first substrate. The first dielectric layer is disposed on the first electrode and includes a first opening. The first opening exposes a portion of the first electrode. The second electrode is disposed on the second substrate. The second dielectric layer is disposed on the second electrode and includes a second opening. The second opening exposes a portion of the second electrode. An area of the first electrode exposed by the first opening is smaller than an area of the second electrode exposed by the second opening. The flow channel layer is sandwiched between the first dielectric layer and the second dielectric layer and includes a through hole. The through hole communicates between the first opening and the second opening.

According to an embodiment of the disclosure, in the chip for sample separation, the first opening, the second opening, and the through hole may be aligned with each other.

According to an embodiment of the disclosure, in the chip for sample separation, a top view area of the through hole may be larger than a top view area of the first opening.

According to an embodiment of the disclosure, in the chip for sample separation, a top view area of the through hole may be larger than or equal to a top view area of the second opening.

According to an embodiment of the disclosure, in the chip for sample separation, the number of the first opening may be one.

According to an embodiment of the disclosure, in the chip for sample separation, the number of the first opening may be multiple.

According to an embodiment of the disclosure, in the chip for sample separation, the number of the second opening may be one.

According to an embodiment of the disclosure, in the chip for sample separation, the number of the second opening may be multiple.

According to an embodiment of the disclosure, in the chip for sample separation, a top view shape of the first opening, a top view shape of the second opening, and a top view shape of the through hole may be a round shape, a polygonal shape, an irregular shape, or a combination thereof.

According to an embodiment of the disclosure, in the chip for sample separation, the first dielectric layer may further include a third opening. The third opening may expose another portion of the first electrode.

According to an embodiment of the disclosure, in the chip for sample separation, the first dielectric layer may further include a fourth opening. The fourth opening may expose another portion of the second electrode.

According to an embodiment of the disclosure, in the chip for sample separation, a material of the first electrode and a material of the second electrode each may include indium tin oxide (ITO), metal, conductive carbon material or a combination thereof.

According to an embodiment of the disclosure, in the chip for sample separation, a thickness of the flow channel layer may range from 20 μm to 100 μm.

According to an embodiment of the disclosure, in the chip for sample separation, a material of the flow channel layer may be light-transmitting dielectric material.

The disclosure provides a sample detection device, including a Raman spectrometer, the chip for sample separation, and an alternating current (AC) power supply device. The chip for sample separation is disposed in the Raman spectrometer. The alternating current power supply device is electrically connected to the first electrode and the second electrode.

The disclosure provides a sample detection method using surface-enhanced Raman spectrum, including the following steps. Provide the chip for sample separation. Provide a sample solution containing a to-be-tested biological sample to a flow channel formed by the first opening, the second opening, and the through hole. Provide an alternating current (AC) to the first electrode and the second electrode, and separate and concentrate the to-be-tested biological sample in the sample solution by an electroosmotic flow and a dielectrophoresis force. Obtain the surface-enhanced Raman spectrum of the separated and concentrated to-be-tested biological sample by a Raman spectrometer. Determine a type of the to-be-tested biological sample by the surface-enhanced Raman spectrum of the to-be-tested biological sample.

According to an embodiment of the disclosure, in the sample detection method using surface-enhanced Raman spectrum, the Raman spectrum of the to-be-tested biological sample may be enhanced by adding a metal particle to the sample solution or by making at least one of the first electrode and the second electrode have a rough metal surface, so as to obtain the surface-enhanced Raman spectrum of the to-be-tested biological sample.

According to an embodiment of the disclosure, in the sample detection method using surface-enhanced Raman spectrum, determining the type of the to-be-tested biological sample by the surface-enhanced Raman spectrum of the to-be-tested biological sample includes the following. Comparing the surface-enhanced Raman spectrum of the to-be-tested biological sample with a standard surface-enhanced Raman spectrum database so as to determine a type of the to-be-tested biological sample, where the standard surface-enhanced Raman spectrum database includes multiple standard surface-enhanced Raman spectra corresponding to multiple standard biological samples.

According to an embodiment of the disclosure, the sample detection method using surface-enhanced Raman spectrum may further include conducting, after determining the type of the to-be-tested biological sample, an antimicrobial susceptibility testing (AST) on the to-be-tested biological sample. The antimicrobial susceptibility testing includes: adding an antibiotic to the sample solution, and measuring, after adding the antibiotic to the sample solution, the surface-enhanced Raman spectrum of the to-be-tested biological sample.

According to an embodiment of the disclosure, in the sample detection method using surface-enhanced Raman spectrum, an alternating current (AC) frequency ranges from 500 Hz to 14 MHz.

Base on the above, in the chip for sample separation, the sample detection device, and the sample detection method using the surface-enhanced Raman spectrum, the area of the first electrode exposed by the first opening is smaller than the area of the second electrode exposed by the second opening. In this way, after providing the alternating current to the first electrode and the second electrode, a change in the electric field gradient at the first electrode exposed by the first opening will be larger than a change in the electric field gradient at the second electrode exposed by the second opening. Therefore, the to-be-tested biological sample in the flow channel of the chip for sample separation can be quickly separated and concentrated by the electroosmotic flow and the dielectrophoresis force, thereby shortening the sample detection process and detection time.

In order to make the above-mentioned features and advantages of the disclosure more obvious and understandable, the embodiments are specifically described below in conjunction with the accompanying drawings for detailed description as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is an exploded view of a chip for sample separation according to an embodiment of the disclosure.

FIG. 1B is a combination view of a chip for sample separation according to an embodiment of the disclosure.

FIG. 1C is a top view of constituent members in a chip for sample separation of FIG. 1A.

FIG. 1D is a cross-sectional view taken along a section line I-I′ in FIG. 1B.

FIG. 2 is a schematic view of a sample detection device according to an embodiment of the disclosure.

FIG. 3 is a flow chart of a sample detection using surface-enhanced Raman spectrum according to an embodiment of the disclosure.

FIG. 4 is a schematic view of separating and concentrating a to-be-tested biological sample in a sample solution by an electroosmotic flow and a dielectrophoresis force according to an embodiment of the disclosure.

FIG. 5 is a view showing a relationship between an alternating current (AC) frequency and a relative dielectrophoresis force constant of an experimental example of the disclosure.

FIG. 6 is a view showing a relationship between an alternating-current frequency and an intensity of a bacteria in a concentrated area of an experimental example of the disclosure.

FIG. 7 is a view showing a relationship between an application time of an alternating current and an intensity of a bacteria in a concentrated area of an experimental example of the disclosure.

FIG. 8 is a view of a surface-enhanced Raman spectrum of an experimental example of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

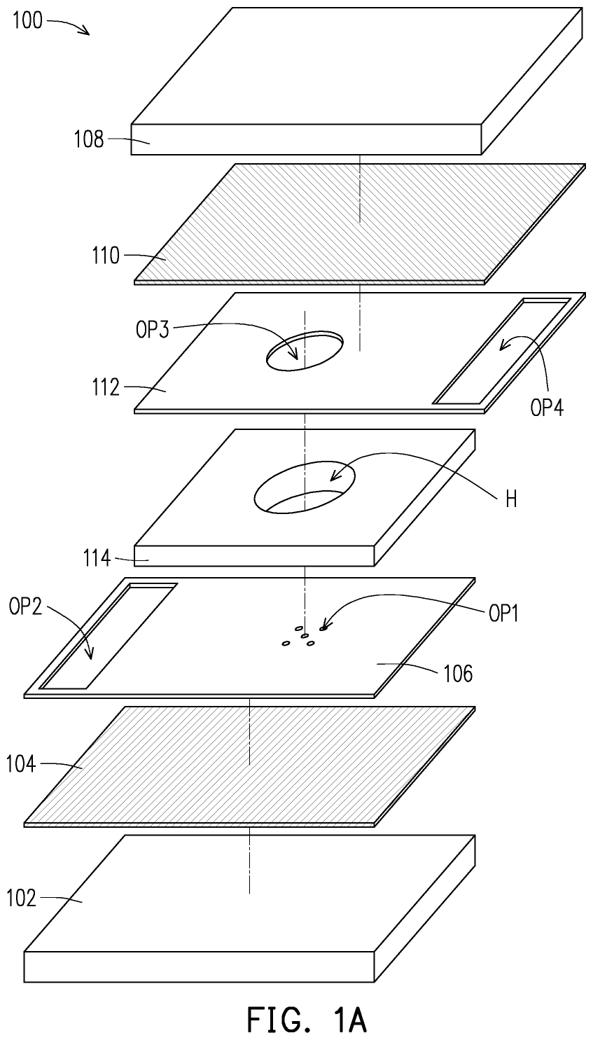

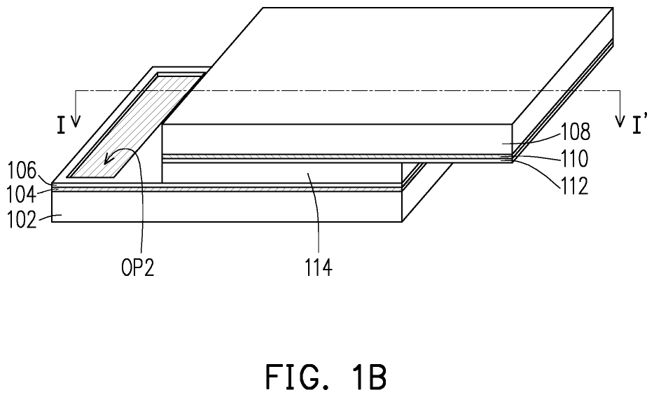

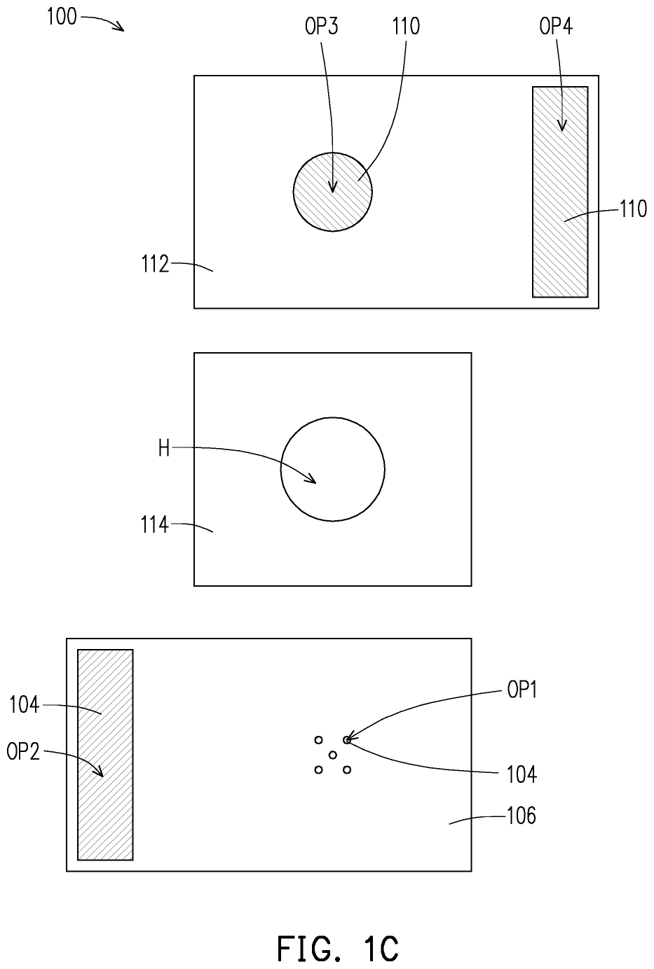

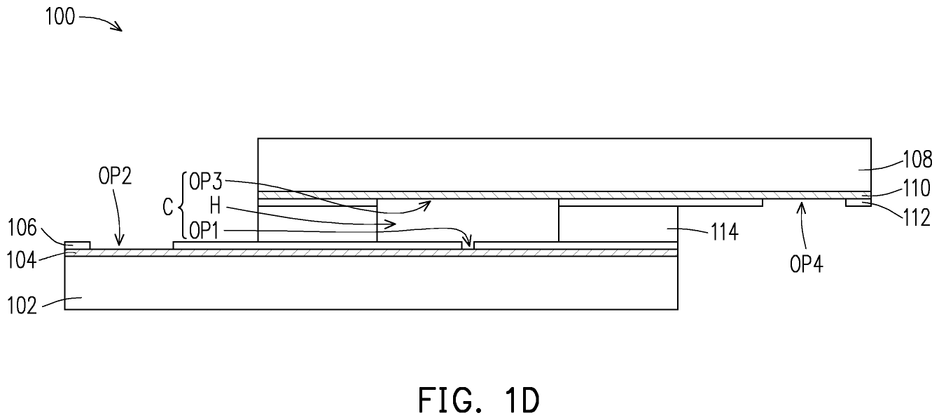

FIG. 1A is an exploded view of a chip for sample separation according to an embodiment of the disclosure. FIG. 1B is a combination view of a chip for sample separation according to an embodiment of the disclosure. FIG. 1C is a top view of constituent members in a chip for sample separation of FIG. 1A. FIG. 1D is a cross-sectional view taken along a section line I-I′ in FIG. 1B.

Referring to FIGS. 1A to 1D, a chip 100 for sample separation includes a substrate 102, an electrode 104, a dielectric layer 106, a substrate 108, an electrode 110, a dielectric layer 112, and a flow channel layer 114. In some embodiments, the chip 100 for sample separation may be, for example, a biological chip configured to separate a biological sample. A material of the substrate 102 and the substrate 108 each may be dielectric material such as glass.

The electrode 104 is disposed on the substrate 102. A material of the electrode 104 may be indium tin oxide, metal, conductive carbon material, or a combination thereof. The electrode 104 may be formed on the substrate 102 by a physical vapor deposition method or a chemical vapor deposition method.

The dielectric layer 106 is disposed on the electrode 104 and includes an opening OP1. The opening OP1 exposes a portion of the electrode 104. The number of the opening OP1 may be one or multiple. The present embodiment takes multiple openings OP1 as an example, but the disclosure is not limited to the number shown in the view. Shapes and areas of the multiple openings OP1 may be the same or different from each other. A top view shape of the opening OP1 may be a round shape, a polygonal shape, an irregular shape, or a combination thereof. The present embodiment takes round shape as an example of the top view shape of the opening OP1, but the disclosure is not limited thereto. Further, the dielectric layer 106 may include an opening OP2. The opening OP2 may expose another portion of the electrode 104. The electrode 104 exposed by the opening OP2 may be electrically connected to a power source (for example, an AC power source). A top view shape of the opening OP2 may be a round shape, a polygonal shape, an irregular shape, or a combination thereof. The present embodiment takes rectangular as an example of the top view shape of the opening OP2, but the disclosure is not limited thereto. A thickness of the dielectric layer 106 may be 200 nm or more. Furthermore, the dielectric layer 106 having the opening OP1 and the opening OP2 may be formed on the electrode 104 by a deposition process, a lithography process, and an etching process.

The electrode 110 is disposed on the substrate 108. A material of the electrode 110 may be indium tin oxide, metal, conductive carbon material, or a combination thereof. The electrode 110 may be formed on the substrate 108 by the physical vapor deposition method or the chemical vapor deposition method.

The dielectric layer 112 is disposed on the electrode 110 and includes an opening OP3. The opening OP3 exposes a portion of the electrode 110. The number of the opening OP3 may be one or multiple. The present embodiment takes one opening OP3 as an example, but the disclosure is not limited thereto. In other embodiments, the number of opening OP3 may be multiple, and shapes and areas of the multiple openings OP3 may be the same or different from each other. A top view shape of the opening OP3 may be a round shape, a polygonal shape, an irregular shape, or a combination thereof. The present embodiment takes round shape as an example of the top view shape of the opening OP3, but the disclosure is not limited thereto. Further, the dielectric layer 112 may further include an opening OP4. The opening OP4 exposes another portion of the electrode 110. The electrode 110 exposed by the opening OP4 may be electrically connected to a power source (for example, an AC power source). A top view shape of the opening OP4 may be a round shape, a polygonal shape, an irregular shape, or a combination thereof. The present embodiment takes rectangular as an example of the top view shape of the opening OP4, but the disclosure is not limited thereto. A thickness of the dielectric layer 112 may be 200 nm or more. Furthermore, the dielectric layer 112 having the opening OP3 and the opening OP4 may be formed on the electrode 110 by the deposition process, the lithography process, and the etching process.

Moreover, an area of the electrode 104 exposed by the opening OP1 is smaller than an area of the electrode 110 exposed by the opening OP3. In this way, after providing an alternating current to the electrode 104 and the electrode 110, a change in an electric field gradient at the electrode 104 exposed by the opening OP1 can be larger than a change in an electric field gradient at the electrode 110 exposed by the opening OP3. In some embodiments, when the number of the opening OP1 is multiple, the “area of the electrode 104 exposed by the opening OP1” refers to “a total area of the electrode 104 exposed by all openings OP1”. In some embodiments, when the number of the opening OP3 is multiple, the “area of the electrode 110 exposed by the opening OP3” refers to “a total area of the electrode 110 exposed by all openings OP3”.

The flow channel layer 114 is sandwiched between the dielectric layer 106 and the dielectric layer 112 and includes a through hole H. The through hole H communicates between the opening OP1 and the opening OP3. A top view shape of the through hole H may be a round shape, a polygonal shape, an irregular shape, or a combination thereof. The present embodiment takes round shape as an example of the top view shape of the through hole H, but the disclosure is not limited thereto. A thickness of the flow channel layer 114 may range from 20 μm to 100 μm. A material of the flow channel layer 114 may be a light-transmitting dielectric material, such as polydimethylsiloxane (PDMS) or other non-conductive materials. Moreover, a mold may be made by the photolithography process and the etching process, and reversed by the light-transmitting dielectric material so as to form the flow channel layer 114.

Further, the opening OP1, the opening OP3, and the through hole H may be aligned with each other. The top view area of the through hole H may be larger than the top view area of the opening OP1. The top view area of the through hole H may be larger than or equal to the top view area of the opening OP3. The present embodiment takes a larger top view area of the through hole H than the top view area of the opening OP3 as an example, but the disclosure is not limited thereto. In addition, referring to FIG. 1D, after combining the substrate 102 provided with the electrode 104 and the dielectric layer 106, the substrate 108 provided with the electrode 110 and the dielectric layer 112, and the flow channel layer 114, the opening OP1, the opening OP3, and the through Hole H may form a flow channel C. In some embodiments, the flow channel C may be configured as a micro flow channel of a biochip. Furthermore, the substrate 102 provided with the electrode 104 and the dielectric layer 106, the substrate 108 provided with the electrode 110 and the dielectric layer 112, and the flow channel layer 114 may be combined by clamping or bonding so as to form the chip 100 for sample separation.

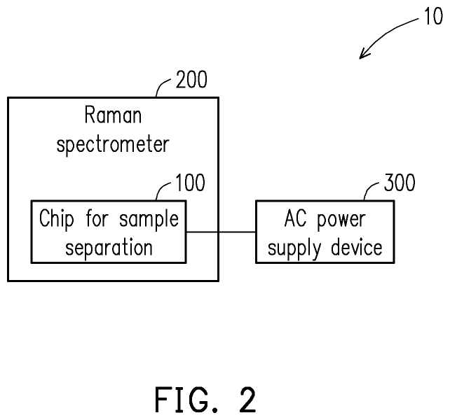

FIG. 2 is a schematic view of a sample detection device according to an embodiment of the disclosure.

Referring to FIG. 2, a sample detection device 10 may include a Raman spectrometer 200, the chip 100 for sample separation, and an AC power supply device 300. When performing sample detection, the chip 100 for sample separation may be disposed in the Raman spectrometer 200. Moreover, when performing sample detection, the AC power supply device 300 may be electrically connected to the electrode 104 and the electrode 110 so as to provide the alternating current to the electrode 104 and the electrode 110.

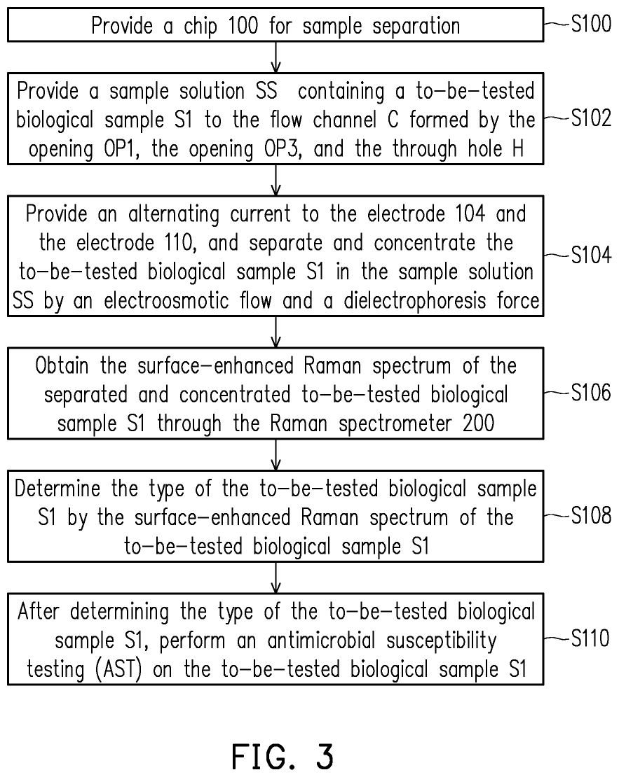

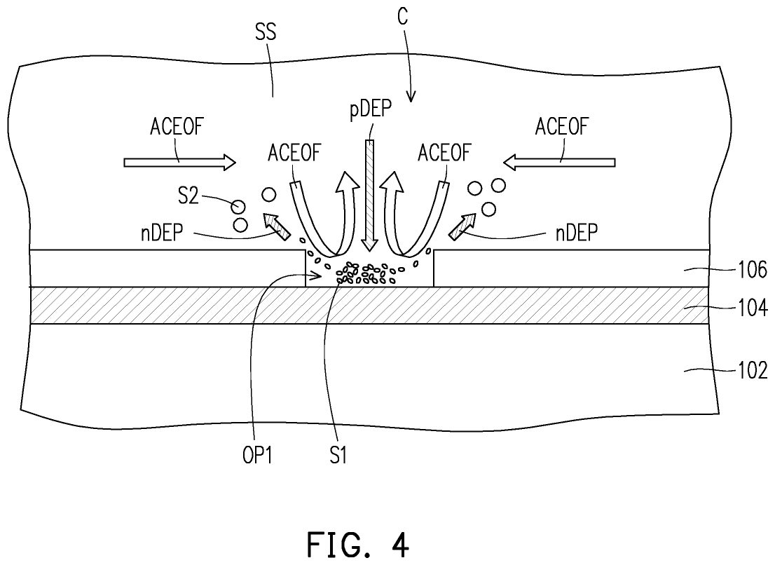

FIG. 3 is a flow chart of a sample detection using surface-enhanced Raman spectrum according to an embodiment of the disclosure. FIG. 4 is a schematic view of separating and concentrating a to-be-tested biological sample in a sample solution by an electroosmotic flow and a dielectrophoresis force according to an embodiment of the disclosure.

Please refer to FIGS. 1A to 1D and FIGS. 2 to 4. In step S100, provide a chip 100 for sample separation. For the details of the chip 100 for sample separation, please refer to the description of the above-mentioned embodiment, which will be omitted here.

Next, in step S102, provide a sample solution SS (FIG. 4) containing a to-be-tested biological sample S1 to the flow channel C formed by the opening OP1, the opening OP3, and the through hole H. As shown in FIG. 4, the sample solution SS may further contain a non-to-be-tested sample S2 in addition to the to-be-tested biological sample S1. For example, the sample solution SS may be blood, and the to-be-tested biological sample S1 may be bacteria (e.g. E. coli). The non-to-be-tested sample S2 may include white blood cells (WBC) and red blood cells (RBC), but the disclosure is not limited thereto.

Next, in step S104, provide an alternating current to the electrode 104 and the electrode 110, and separate and concentrate the to-be-tested biological sample S1 in the sample solution SS by an electroosmotic flow and a dielectrophoresis force. For example, the alternating current may be provided to the electrode 104 and the electrode 110 by the AC power supply device 300 in FIG. 2. An alternating-current frequency may range from 500 Hz to 14 MHz. An alternating-current voltage may range from 1 volt (V) to 100 volts, which is limited by a resistance of the dielectric material used. In some embodiments, the alternating-current voltage applied to the electrode 104 and the electrode 110 may be the same, and the alternating-current frequency applied to the electrode 104 and the electrode 110 may be the same.

Since an area of the electrode 104 exposed by the opening OP1 is smaller than an area of the electrode 110 exposed by the opening OP3, after providing the alternating current to the electrode 104 and the electrode 110, the change the an electric field gradient at the electrode 104 exposed by the opening OP1 will be greater than the change in the electric field gradient at the electrode 110 exposed by the opening OP3. The movement of a substance under the action of an uneven electric field will be different due to the dielectric constant and size of the substance and the dielectric constant of the dielectric substance. Therefore, the to-be-tested biological sample S1 located in the flow channel C of the chip 100 for sample separation can be quickly separated and concentrated by the electroosmotic flow and the dielectrophoresis force. For example, as shown in FIG. 4, when the to-be-tested biological sample S1 is mainly affected by an alternating current electroosmotic flow (ACEOF) and a positive electrophoresis force pDEP, the to-be-tested biological sample S1 will be concentrated at the electrode 104 exposed by the opening OP1 due to an adsorption force. In addition, as shown in FIG. 4, when the non-to-be-tested sample S2 is mainly affected by the alternating current electroosmotic flow (ACEOF) and a negative electrophoresis force nDEP, the non-to-be-tested sample S2 will be far away from the electrode 104 exposed by the opening OP1 due to a repulsive force. In this way, the to-be-tested biological sample S1 in the sample solution SS can be quickly separated and concentrated.

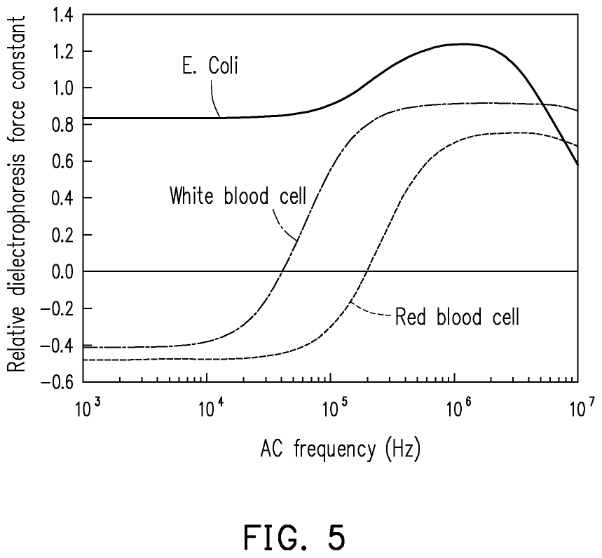

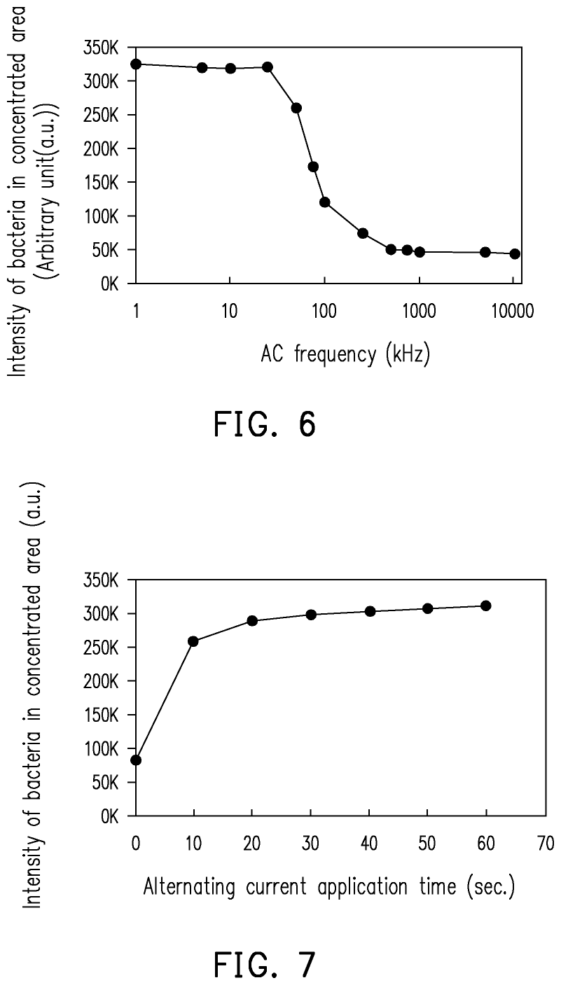

FIG. 5 is a view showing a relationship between an alternating-current frequency and a relative dielectrophoresis force constant of an experimental example of the disclosure. FIG. 6 is a view showing a relationship between an alternating-current frequency and an intensity of a bacteria in a concentrated area of an experimental example of the disclosure. FIG. 7 is a view showing a relationship between an application time of an alternating current and an intensity of a bacteria in a concentrated area of an experimental example of the disclosure.

In an experimental example, the sample solution SS may be blood, the to-be-tested biological sample S1 may be E. coli, and the non-to-be-tested sample S2 may be white blood cells and red blood cells. As shown in FIG. 5, when the alternating-current voltage used in the sample detection method is 5V and the alternating-current frequency is 1 kHz to 41 kHz, E. coli is subject to a positive dielectrophoresis force, and white blood cells and red blood cells are subject to a negative dielectrophoresis force. Therefore, the alternating-current frequency within the alternating-current frequency range may be selected so as to separate and concentrate the E. coli. As shown in FIG. 6, when the alternating-current voltage used in the sample detection method is 5V and the alternating-current frequency is 1 kHz to 41 kHz, the separation effect and concentration effect of the E. coli can be better. As shown in FIG. 7, when the alternating-current voltage used in the sample detection method is 5V and the alternating-current frequency is 5 kHz, E. coli can be effectively separated and concentrated in a short time (for example, within 10 seconds).

Please continue to refer to FIGS. 1A to 1D and FIGS. 2 and 3. In step S106, obtain the surface-enhanced Raman spectrum of the separated and concentrated to-be-tested biological sample S1 through the Raman spectrometer 200. For example, the chip 100 for sample separation in a power-on state may be disposed in the surface-enhanced Raman spectrometer 200 so as to obtain the surface-enhanced Raman spectrum of the to-be-tested biological sample S1. In the present embodiment, “surface-enhanced Raman spectrum” refers to a spectrum obtained by the surface-enhanced Raman scattering (SERS). In some embodiments, the Raman spectrum of the to-be-tested biological sample S1 may be enhanced by adding metal particles in the sample solution SS or making at least one of the electrode 104 and the electrode 110 have a rough metal surface so as to obtain the surface-enhanced Raman spectrum of the to-be-tested biological sample S1. The metal particles may be nano-scale particles. The materials of the metal particles may be silver, gold, platinum, nickel, copper or a combination thereof.

Next, in step S108, determine the type of the to-be-tested biological sample S1 by the surface-enhanced Raman spectrum of the to-be-tested biological sample S1. For example, the method of determining the type of the to-be-tested biological sample S1 by the surface-enhanced Raman spectrum of the to-be-tested biological sample S1 may include the following steps. Compare the surface-enhanced Raman spectrum of to-be-tested biological sample S1 with the standard surface-enhanced Raman spectrum database to determine the type of to-be-tested biological sample S1. The standard surface-enhanced Raman spectrum database includes multiple standard surface-enhanced Raman spectra corresponding to multiple standard biological samples. In some embodiments, the standard surface-enhanced Raman spectrum database may be stored in the memory of a computer system, and the computer system may compare the surface-enhanced Raman spectrum of the to-be-tested biological sample S1 with the standard surface-enhanced Raman spectrum database so as to determine the type of the to-be-tested biological sample S1.

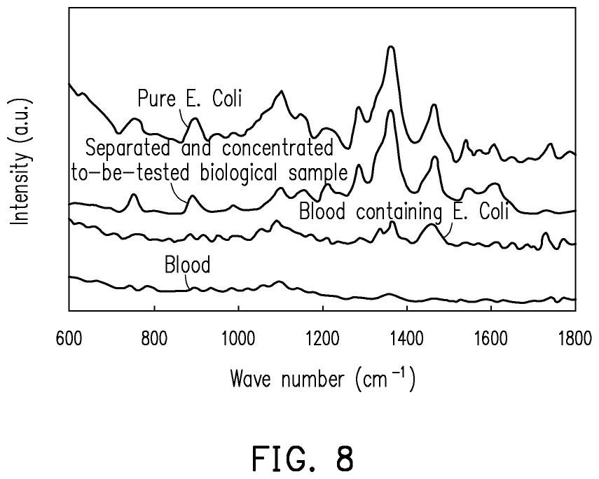

FIG. 8 is a view of a surface-enhanced Raman spectrum view of an experimental example of the disclosure.

As shown in FIG. 8, the surface-enhanced Raman spectrum of to-be-tested biological sample S1 (E. coli) separated and concentrated by the sample detection method has high similarity with the standard surface-enhanced Raman spectrum of pure E. coli. Therefore, it can be determined that the type of the to-be-tested biological sample S1 is E. coli. In addition, as shown in FIG. 8, the surface-enhanced Raman spectrum of blood containing E. coli has low similarity with the standard surface-enhanced Raman spectrum of pure E. coli. Therefore, it is difficult to directly determine from the surface-enhanced Raman spectrum of the blood containing E. coli that the to-be-tested biological sample S1 is E. coli. In addition, as shown in FIG. 8, the surface-enhanced Raman spectrum of blood has low similarity with the standard surface-enhanced Raman spectrum of pure E. coli.

Please continue to refer to FIGS. 1A to 1D, FIGS. 2 and 3. In step 5110, after determining the type of the to-be-tested biological sample S1, perform an antimicrobial susceptibility testing (AST) on the to-be-tested biological sample S1 (e.g. pathogens such as bacteria). The antimicrobial susceptibility testing includes the following steps. First, add an antibiotic to the sample solution. Then, after adding the antibiotic to the sample solution, measure the surface-enhanced Raman spectrum of the to-be-tested biological sample S1. For example, after adding the antibiotic to the sample solution, the chip 100 for sample separation in the power-on state may be disposed in the surface-enhanced Raman spectrometer 200 so as to measure the surface-enhanced Raman spectrum of the to-be-tested biological sample S1. After adding the antibiotic to the sample solution, if a surface-enhanced Raman spectrum signal of the to-be-tested biological sample S1 disappears or is reduced by a certain degree (for example, a reduction of more than 50%), the antibiotic can be judged to be effective. Conversely, after adding the antibiotic to the sample solution, if a strong surface-enhanced Raman spectrum signal of the to-be-tested biological sample S1 is still obtained, the antibiotic can be judged to be ineffective.

Based on the embodiments, it can be seen that in the hip 100 for sample separation, sample detection device 10, and the sample detection method using surface-enhanced Raman spectrum, the area of the electrode 104 exposed by the opening OP1 is smaller than the area of the electrode 110 exposed by the opening OP3. In this way, after the alternating current is provided to the electrode 104 and the electrode 110, the change in the electric field gradient at the electrode 104 exposed by the opening OP1 will be larger than the change in the electric field gradient at the electrode 110 exposed by the opening OP3. Therefore, the to-be-tested biological sample S1 located in the flow channel C of the chip 100 for sample separation can be quickly separated and concentrated by the electroosmotic flow and the dielectrophoresis force, thereby shortening the sample detection process and detection time.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A chip for sample separation, comprising:
a first substrate;
a first electrode, disposed on the first substrate;
a first dielectric layer, disposed on the first electrode and comprising a first opening, wherein the first opening exposes a portion of the first electrode;
a second substrate;
a second electrode, disposed on the second substrate;
a second dielectric layer, disposed on the second electrode and comprising a second opening, wherein the second opening exposes a portion of the second electrode, and an area of the first electrode exposed by the first opening is smaller than an area of the second electrode exposed by the second opening; and
a flow channel layer, sandwiched between the first dielectric layer and the second dielectric layer and comprising a through hole, wherein the through hole communicates between the first opening and the second opening.

2. The chip for sample separation as described in claim 1, wherein the first opening, the second opening, and the through hole are aligned with each other.

3. The chip for sample separation as described in claim 1, wherein a top view area of the through hole is larger than a top view area of the first opening.

4. The chip for sample separation as described in claim 1, wherein a top view area of the through hole is larger than or equal to a top view area of the second opening.

5. The chip for sample separation as described in claim 1, wherein the number of the first opening is one.

6. The chip for sample separation as described in claim 1, wherein the number of the first opening is plural.

7. The chip for sample separation as described in claim 1, wherein the number of the second opening is one.

8. The chip for sample separation as described in claim 1, wherein the number of the second opening is plural.

9. The chip for sample separation as described in claim 1, wherein a top view shape of the first opening, a top view shape of the second opening, and a top view shape of the through hole each comprises a round shape, a polygonal shape, an irregular shape, or a combination thereof.

10. The chip for sample separation as described in claim 1, wherein the first dielectric layer further comprises a third opening, wherein the third opening exposes another portion of the first electrode.

11. The chip for sample separation as described in claim 1, wherein the second dielectric layer further comprises a fourth opening, wherein the fourth opening exposes another portion of the second electrode.

12. The chip for sample separation as described in claim 1, wherein a material of the first electrode and a material of the second electrode each comprises indium tin oxide, metal, conductive carbon material or a combination thereof.

13. The chip for sample separation as described in claim 1, wherein a thickness of the flow channel layer ranges from 20 μm to 100 μm.

14. The chip for sample separation as described in claim 1, wherein a material of the flow channel layer comprises light-transmitting dielectric material.

15. A sample detection device, comprising:
a Raman spectrometer;
the chip for sample separation as described in claim 1, disposed in the Raman spectrometer; and
an alternating current (AC) power supply device, electrically connected to the first electrode and the second electrode.

16. A sample detection method using surface-enhanced Raman spectrum, the sample detection method comprising:
providing the chip for sample separation as described in request item 1;
providing a sample solution containing a to-be-tested biological sample to a flow channel formed by the first opening, the second opening, and the through hole;
providing an alternating current (AC) to the first electrode and the second electrode, and separating and concentrating the to-be-tested biological sample in the sample solution by an electroosmotic flow and a dielectrophoresis force;
obtaining the surface-enhanced Raman spectrum of the separated and concentrated to-be-tested biological sample by a Raman spectrometer; and
determining a type of the to-be-tested biological sample by the surface-enhanced Raman spectrum of the to-be-tested biological sample.

17. The sample detection method using surface-enhanced Raman spectrum as described in claim 16, wherein the Raman spectrum of the to-be-tested biological sample is enhanced by adding a metal particle to the sample solution or by making at least one of the first electrode and the second electrode have a rough metal surface, so as to obtain the surface-enhanced Raman spectrum of the to-be-tested biological sample.

18. The sample detection method using surface-enhanced Raman spectrum as described in claim 16, wherein a method of determining the type of the to-be-tested biological sample by the surface-enhanced Raman spectrum of the to-be-tested biological sample comprises:
comparing the surface-enhanced Raman spectrum of the to-be-tested biological sample with a standard surface-enhanced Raman spectrum database so as to determine a type of the to-be-tested biological sample, wherein the standard surface-enhanced Raman spectrum database comprises a plurality of standard surface-enhanced Raman spectra corresponding to a plurality of standard biological samples.

19. The sample detection method using surface-enhanced Raman spectrum as described in claim 16, further comprising, conducting, after determining the type of the to-be-tested biological sample, an antimicrobial susceptibility testing on the to-be-tested biological sample, wherein the antimicrobial susceptibility testing comprises:
adding an antibiotic to the sample solution; and
measuring, after adding the antibiotic to the sample solution, the surface-enhanced Raman spectrum of the to-be-tested biological sample.

20. The sample detection method using surface-enhanced Raman spectrum as described in claim 16, wherein an alternating-current frequency ranges from 500 Hz to 14 MHz.
